(19) United States
(12) Patent Application Publication
(10) Pub. No.: US 2024/0241004 A1
(43) Pub. Date: Jul. 18, 2024

(54) SENSOR ASSEMBLY WITH A FULL-BRIDGE PRESSURE SENSOR

(71) Applicant: TE Connectivity Solutions GmbH, Schaffhausen (CH)

(72) Inventors: Ramprasad Nambisan, Fremont, CA (US); Predrag Drljaca, Muhlenstrasse (CH)

(73) Assignee: TE Connectivity Solutions GmbH, Schaffausen (CH)

(21) Appl. No.: 18/155,836

(22) Filed: Jan. 18, 2023

(51) Int. Cl. G01L 9/06; G01L 9/00

(52) U.S. Cl. CPC G01L 9/06; G01L 9/0042

(57) ABSTRACT

A sensor assembly includes a substrate having a first outer surface and a second outer surface opposite the first outer surface, a first die attached to the first outer surface and having a first diaphragm, a second die attached to the second outer surface and having a second diaphragm, and a full-bridge pressure sensor including a plurality of piezoresistive elements. A first subset of at least two of the plurality of piezoresistive elements is disposed on the first diaphragm and a second subset of at least two of the plurality of piezoresistive elements is disposed on the second diaphragm.

### FIELD OF THE INVENTION

The present invention relates to a sensor and, more particularly, to a sensor assembly including a full-bridge pressure sensor.

### BACKGROUND

A pressure sensor commonly includes a sensor diaphragm and piezoresistors disposed on the sensor diaphragm. An applied force or pressure deflects the sensor diaphragm, which changes the resistance of the piezoresistors on the diaphragm, correspondingly changing a measured output of the pressure sensor that reflects the force or pressure.

A full-bridge pressure sensor is used to increase the accuracy and reliability of the sensor measurements. The full-bridge sensor, however, requires a sensor diaphragm sized to accommodate four piezoresistors to form the full Wheatstone bridge, which increases the necessary size of the pressure sensor. Current solutions cannot provide the accuracy and performance of a full-bridge sensor in applications, such as medical applications, that have significant size restrictions.

### SUMMARY

A sensor assembly includes a substrate having a first outer surface and a second outer surface opposite the first outer surface, a first die attached to the first outer surface and having a first diaphragm, a second die attached to the second outer surface and having a second diaphragm, and a full-bridge pressure sensor including a plurality of piezoresistive elements. A first subset of at least two of the plurality of piezoresistive elements is disposed on the first diaphragm and a second subset of at least two of the plurality of piezoresistive elements is disposed on the second diaphragm.

### BRIEF DESCRIPTION OF THE DRAWINGS

The invention will now be described by way of example with reference to the accompanying Figures, of which:

FIG. 1 is a schematic diagram of a sensor assembly according to an embodiment;

FIG. 2 is a schematic diagram of a sensor assembly according to another embodiment;

FIG. 3 is a schematic diagram of a sensor assembly according to another embodiment;

FIG. 4 is a schematic diagram of a sensor assembly according to another embodiment;

FIG. 5 is a schematic diagram of a sensor assembly according to another embodiment; and

FIG. 6 is a schematic diagram of a sensor assembly according to another embodiment.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth to provide a thorough understanding of the disclosed embodiments. However, it is apparent that one or more embodiments may also be implemented without these specific details.

Throughout the drawings, only one of a plurality of identical elements may be labeled in a figure for clarity of the drawings, but the detailed description of the element herein applies equally to each of the identically appearing elements in the figure. Directional descriptors used in the specification are merely for clarity of the description and for differentiation of the various directions. These directional descriptors do not imply or require any particular orientation of the disclosed elements.

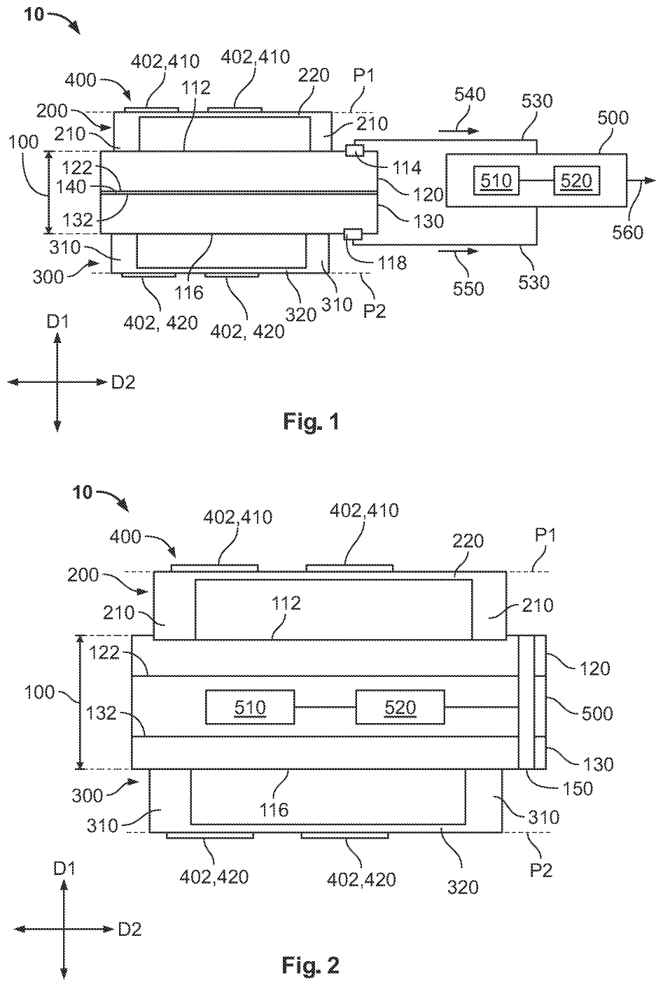

A sensor assembly 10 according to an embodiment is shown in FIG. 1. The sensor assembly 10 includes a substrate 100, a first die 200 attached to the substrate 100, a second die 300 attached to the substrate 100, a full-bridge pressure sensor 400 disposed on the first die 200 and the second die 300, and an integrated circuit 500 connected to the full-bridge pressure sensor 400.

The substrate 100 has a first outer surface 112 and a second outer surface 116 opposite the first outer surface 112 in a first direction D1, shown in FIG. 1. The substrate 100 may be a silicon material, a glass material, a sapphire material, or any other type of material used in piezoresistive sensor substrates.

In the embodiment shown in FIG. 1, the substrate 100 includes a first portion 120 and a second portion 130 formed separately from one another and bonded together at a bond 140. The first portion 120 and the second portion 130 are each formed of the material of the substrate 100. The first portion 120 has the first outer surface 112 and a first inner surface 122 opposite the first outer surface 112 in the first direction D1. The second portion 130 has the second outer surface 116 and a second inner surface 132 opposite the second outer surface 116 in the first direction D1. The first inner surface 122 is bonded to the second inner surface 132 by the bond 140, which may be a fusion bond, an epoxy bond, an anodic bond, a eutectic bond, or any other type of bond that can attach the first portion 120 to the second portion 130. In some embodiments, the bond 140 may be electrically conductive and form an electrical connection. In another embodiment, the substrate 100 can be formed monolithically in a single piece with the first outer surface 112 and the second outer surface 116.

As shown in the embodiment of FIG. 1, the substrate 100 has a first contact 114 on the first outer surface 112 and a second contact 118 on the second outer surface 116. The first contact 114 and the second contact 118 may be formed of any conductive material, such as gold or copper, that permits an external electrical connection.

The first die 200, as shown in FIG. 1, has a pair of first supports 210 and a first diaphragm 220 extending between the first supports 210. The first diaphragm 220 is deflectable with respect to the first supports 210. The first die 200 is formed of a silicon material. In an embodiment, the first die 200 is monolithically formed in a single piece with the first supports 210 and the first diaphragm 220, and the silicon material of the first die 220 is etched to form the first diaphragm 220. In another embodiment, the first diaphragm 220 is formed separately from the first supports 210 and is attached to the first supports 210.

The second die 300, as shown in FIG. 1, has a pair of second supports 310 and a second diaphragm 320 extending between the second supports 310. The second diaphragm 320 is deflectable with respect to the second supports 310. The second die 300 is formed of a silicon material. In an embodiment, the second die 300 is monolithically formed in a single piece with the second supports 310 and the second diaphragm 320, and the silicon material of the second die 300 is etched to form the second diaphragm 320. In another embodiment, the second diaphragm 320 is formed separately from the second supports 310 and is attached to the second supports 310. In an embodiment, the first die 200 and the second die 300 are identical.

The full-bridge pressure sensor 400, as shown in FIG. 1, includes a plurality of piezoresistive elements 402 disposed on the first die 200 and the second die 300. The piezoresistive elements 402 include a first subset 410 of at least two of the piezoresistive elements 402 disposed on the first diaphragm 220 and a second subset 420 of at least two of the piezoresistive elements 402 disposed on the second diaphragm 320. The piezoresistive elements 402 are an elemental material that is patterned over or embedded into the silicon material of the first die 200 and the second die 300; the piezoresistive elements 402 can be positioned on a surface of or within the diaphragms 220, 320. In an embodiment, the elemental material is a positive dopant, such as p-type boron, but could be any type of material used to create a piezoresistor in a silicon material.

The full-bridge pressure sensor 400 includes four piezoresistive elements 402 in the shown embodiment that form a full Wheatstone bridge. In this embodiment, the first subset 410 is a first half-bridge that includes two piezoresistive elements 402 on the first diaphragm 220 and the second subset 420 is a second half-bridge that includes another two piezoresistive elements 402 on the second diaphragm 320, as shown in FIG. 1.

As shown in FIG. 1, the integrated circuit 500 has a processor 510 and a memory 520 connected to the processor 510. The memory 520 is a non-transitory computer-readable medium storing algorithms that, when executed by the processor 510, perform the functions of the integrated circuit 500 described herein. The integrated circuit 500 can be any kind of application-specific integrated circuit (ASIC) or application-specific standard product (ASSP) chip that is capable of being used in piezoresitive sensor applications as described herein.

In the sensor assembly 10 shown in FIG. 1, the first die 200 is attached to the first outer surface 112 and the second die 300 is attached to the second outer surface 116. The first supports 310 of the first die 200 are bonded to the first outer surface 112, for example by fusion bonding, anodic bonding, thermal compression, or solder, and separate the first diaphragm 220 from the first outer surface 112 in the first direction D1. The first diaphragm 220 with the first subset 410 of the piezoresistive elements 402 is deflectable toward the first outer surface 112 in the first direction D1. The second supports 310 of the second die 300 are bonded to the second outer surface 116, for example by fusion bonding, anodic bonding, thermal compression, or solder, and separate the second diaphragm 320 from the second outer surface 116 in the first direction D1. The second diaphragm 320 with the second subset 420 of piezoresistive elements 402 is deflectable toward the second outer surface 116 in the first direction D1.

In the shown embodiment, the first subset 410 of piezoresistive elements 402 are disposed on a side of the first diaphragm 220 facing away from the first outer surface 112 in the first direction D1 and the second subset 420 of piezoresistive elements 402 are disposed on a side of the second diaphragm 320 facing away from the second outer surface 116 in the first direction D1. In another embodiment, the first subset 410 may be disposed on a side of the first diaphragm 220 facing the first outer surface 112 and the second subset 420 may be disposed on a side of the second diaphragm 320 facing the second outer surface 116. In another embodiment, the first subset 410 can be embedded within the first diaphragm 220 and the second subset 420 can be embedded within the second diaphragm 320. In another embodiment, the first contact 114 can alternatively be positioned on the first diaphragm 220 and the second contact 118 can be positioned on the second diaphragm 320.

The first subset 410 on the first diaphragm 220 lies in a first plane P1 normal to the first direction D1 and parallel to the first outer surface 112, and the second subset 420 on the second diaphragm 320 lies in a second plane P2 normal to the first direction D1 and parallel to the second outer surface 116. As shown in FIG. 1, the first plane P1 is separated from the second plane P2 in the first direction D1. In the embodiment of the sensor assembly 10 shown in FIG. 1, the first die 200 with the first subset 410 and the second die 300 with the second subset 420 are mirror symmetrical about the substrate 100.

The integrated circuit 500, as shown in FIG. 1, has a pair of electrical leads 530 connected to the first contact 114 and the second contact 118. The integrated circuit 500 is electrically connected to the piezoresistive elements 402 of the first subset 410 and the second subset 420 through the contacts 114, 118. In the embodiment shown in FIG. 1, the integrated circuit 500 is external to and spaced apart from the substrate 100, the first die 200, and the second die 300.

In use of the sensor assembly 10 to measure a force or pressure, the pressure causes deflection of the first diaphragm 220 and the second diaphragm 320, which changes a resistance of the first subset 410 and the second subset 420 of the piezoresistive elements 402 forming the full-bridge pressure sensor 400. The first subset 410 or first half-bridge is electrically connected to the first contact 114 and a first signal 540 representing the change in resistance of the first subset 410 that corresponds to the pressure measured by the first subset 410 is transmitted to the integrated circuit 500 through the first contact 114 and one of the electrical leads 530. The second subset 420 or second half-bridge is electrically connected to the second contact 118 and a second signal 550 representing the same applied pressure is transmitted to the integrated circuit 500 through the second contact 118 and one of the electrical leads 530.

Even though the first subset 410 and the second subset 420 act as a full-bridge sensor 400 to measure the same pressure applied to the sensor assembly 10, because the first subset 410 and the second subset 420 are positioned in the planes P1, P2 spaced apart from one another, the first signal 540 and the second signal 550 may have some difference due to positional variations in the applied pressure. The integrated circuit 500 has a calibration algorithm stored on the memory 520 that, when executed by the processor 510, corrects a signal error between the first signal 540 and the second signal 550. The processor 510 retrieves a calibrated value stored in the memory 520 based on known temperature and pressure and compares it to the signals 540, 550 to generate the correct compensation for the signal error. The integrated circuit 500 combines the first signal 540 and the second signal 550 to output a measured pressure 560 applied to the sensor assembly 10 and measured by the full bridge pressure sensor 400.

Other exemplary embodiments of the sensor assembly 10 are shown in FIGS. 2-6. Like reference numbers refer to like elements with respect to the embodiment of the sensor assembly 10 shown in FIG. 1, and primarily the differences of the embodiments in FIGS. 2-6 will be described in detail.

In the sensor assembly 10 shown in FIG. 2, the integrated circuit 500 is positioned or interposed between the first portion 120 and the second portion 130 of the substrate 100. The first inner surface 122 of the first portion 120 is attached or bonded to a first side of the integrated circuit 500 and the second inner surface 132 is attached or bonded to a second side of the integrated circuit 500 opposite the first side in the first direction D1.

In the embodiment shown in FIG. 2, instead of the contacts 114, 118 in the embodiment of FIG. 1, the integrated circuit 500 disposed between the portions 120, 130 of the substrate 110 is electrically connected to the first subset 410 and the second subset 420 of the full-bridge pressure sensor 400 by a via 150. The via 150 extends from the first outer surface 112 to the second outer surface 116 of the substrate 100, through the first portion 120, the integrated circuit 500, and the second portion 130. In an embodiment, the via 150 is a passageway through the portions 120, 130 and the integrated circuit 500 that is plated with an electrically conductive material, such as copper.

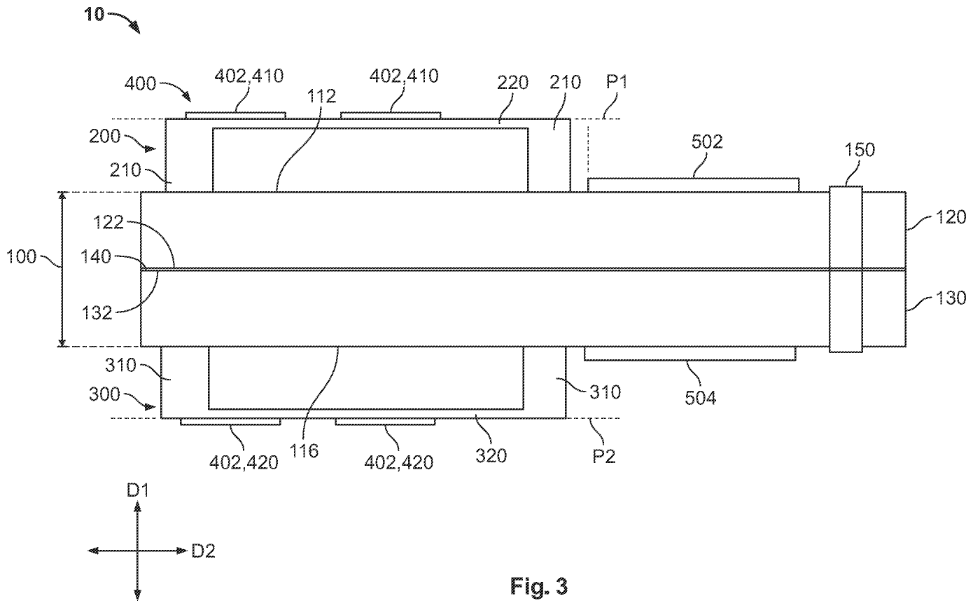

In the embodiments shown in FIGS. 3-6, the sensor assembly 10 includes a first integrated circuit 502 and a second integrated circuit 504 that each include the components of the integrated circuit 500 described above. The first integrated circuit 502 is disposed on the first outer surface 112 adjacent to the first die 200 and the second integrated circuit 504 is disposed on the second outer surface 116 adjacent to the second die 300. The first integrated circuit 502 is connected to the first subset 410 and processes the signal from the first subset 410 while the second integrated circuit 504 is connected to the second subset 420 and processes the signal from the second subset 420. The integrated circuits 502, 504 are further connected to one another, with either or both of the integrated circuits 502, 504 capable of performing the aforementioned correction of signal error and outputting of the measured pressure 560 sensed by the full-bridge pressure sensor 400. In another embodiment, the sensor assembly 10 can include one of the first integrated circuit 502 disposed on the first outer surface 112 or the second integrated circuit 504 disposed on the second outer surface 116.

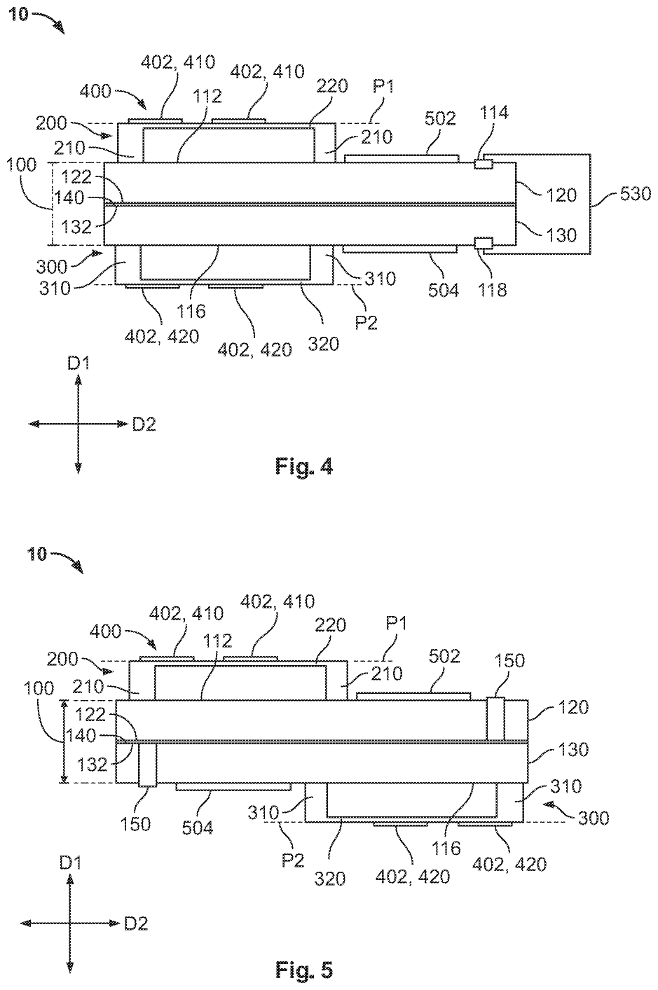

In the embodiments shown in FIGS. 3 and 4, the dies 200, 300 and the integrated circuits 502, 504 are positioned mirror symmetrical about the substrate 100. In another embodiment shown in FIG. 5, the dies 200, 300 and the integrated circuits 502, 504 are offset from one another in a second direction D2 perpendicular to the first direction D1 and parallel to the first outer surface 112 and the second outer surface 116.

In the embodiments of FIGS. 3 and 5, the piezoresistive elements 402 of the full-bridge pressure sensor 400 and the integrated circuits 502, 504 are electrically connected by the via 150. The via 150 can extend straight through the portions 120, 130 of the substrate 100 in the first direction D1, as shown in FIG. 3, or can have different sections in the portions 120, 130 that are electrically connected and offset from one another in the second direction D2, as shown in FIG. 5. In the embodiment of FIG. 4, the piezoresistive elements 402 of the full-bridge pressure sensor 400 and the integrated circuits 502, 504 are electrically connected by external electrical leads 530 connecting contacts 114, 118 on the outer surfaces 112, 116 of the substrate 100, as similarly described with respect to FIG. 1 above.

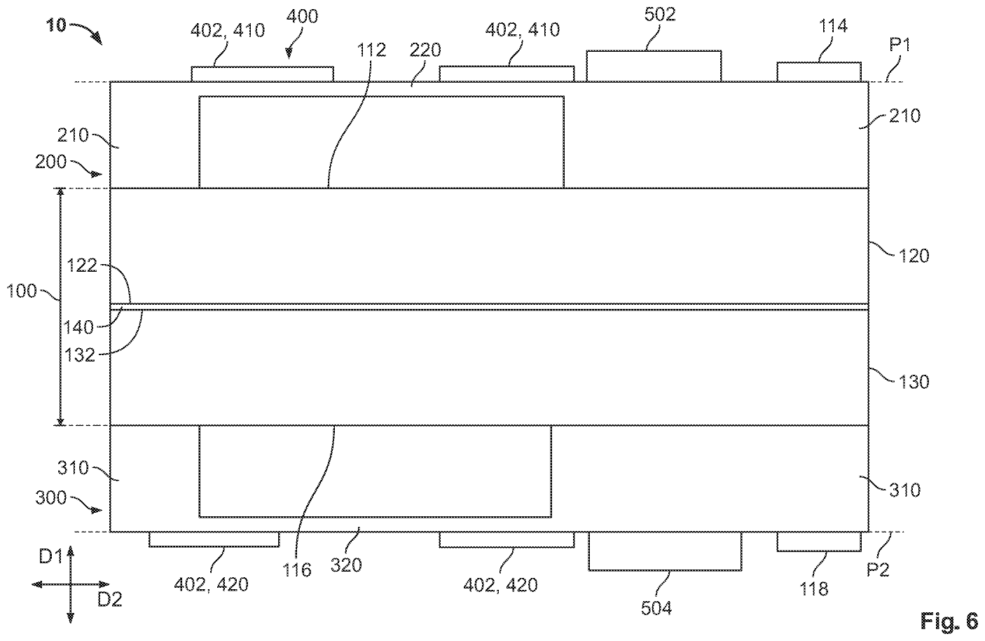

In the embodiment of FIG. 6, at least one of the first supports 210 is sufficiently wide in the second direction D2 that the first integrated circuit 502 and the first contact 114 are disposed on a surface of the first die 200. The first integrated circuit 502 and the first contact 114 are aligned with the first support 120 in the first direction D1 and spaced apart from the first diaphragm 220 in the second direction D2. Likewise, at least one of the second supports 310 is sufficiently wide in the second direction D2 that the second integrated circuit 504 and the second contact 118 are disposed on a surface of the second die 300. The second integrated circuit 504 and the second contact 118 are aligned with the second support 310 in the first direction D1 and spaced apart from the second diaphragm 320 in the second direction D2.

In the embodiments of the sensor assembly 10 described above, splitting the piezoresistors 402 of the full-bridge pressure sensor 400 into the first subset 410 and the second subset 420 positioned on different diaphragms 220, 320 and attaching the dies 200, 300 having the diaphragms 220, 320 to the substrate 100 in a stacked orientation in the first direction D1 decreases the overall size or footprint of the sensor assembly 10. Combining the signals 540, 550 from the two subsets 410, 420 into the measured pressure 560 allows for the increased sensitivity and performance of a full-bridge pressure sensor 400 while significantly decreasing the necessary overall size of the sensor assembly 10, permitting greater accuracy of pressure measurements in size-restricted applications.

What is claimed is:

1. A sensor assembly, comprising:
a substrate having a first outer surface and a second outer surface opposite the first outer surface;
a first die attached to the first outer surface and having a first diaphragm;
a second die attached to the second outer surface and having a second diaphragm; and
a full-bridge pressure sensor including a plurality of piezoresistive elements, a first subset of at least two of the plurality of piezoresistive elements is disposed on the first diaphragm and a second subset of at least two of the plurality of piezoresistive elements is disposed on the second diaphragm.

2. The sensor assembly of claim 1, wherein the substrate includes a first portion and a second portion, the first portion has the first outer surface and a first inner surface opposite the first outer surface, the second portion has the second outer surface and a second inner surface opposite the second outer surface.

3. The sensor assembly of claim 2, wherein the first inner surface is bonded to the second inner surface.

4. The sensor assembly of claim 1, wherein the first die has a pair of first supports attached to the first outer surface and separating the first diaphragm from the first outer surface, the first diaphragm is deflectable toward the first outer surface, the second die has a pair of second supports attached to the second outer surface and separating the second diaphragm from the second outer surface, the second diaphragm is deflectable toward the second outer surface.

5. The sensor assembly of claim 4, wherein the second die is mirror symmetrical to the first die about the substrate.

6. The sensor assembly of claim 4, wherein the second die is offset from the first die in a direction parallel to the first outer surface and the second outer surface.

7. The sensor assembly of claim 1, further comprising an integrated circuit, the first subset and the second subset of the piezoresistive elements are connected to the integrated circuit.

8. The sensor assembly of claim 7, wherein the integrated circuit receives a first signal from the first subset and a second signal from the second subset, the integrated circuit corrects a signal error between the first signal and the second signal measuring a pressure around the sensor assembly.

9. The sensor assembly of claim 8, wherein the substrate includes a first portion and a second portion, the first portion has the first outer surface and a first inner surface opposite the first outer surface, the second portion has the second outer surface and a second inner surface opposite the second outer surface, the integrated circuit is interposed between the first inner surface and the second inner surface.

10. The sensor assembly of claim 8, wherein the integrated circuit is disposed on the first outer surface or the second outer surface.

11. The sensor assembly of claim 10, wherein the integrated circuit is a first integrated circuit disposed on the first outer surface and further comprising a second integrated circuit disposed on the second outer surface.

12. The sensor assembly of claim 8, wherein the substrate has a via extending through the substrate from the first outer surface to the second outer surface, the via electrically connects the first subset and the second subset with the integrated circuit.

13. The sensor assembly of claim 8, wherein the integrated circuit is external to and spaced apart from the substrate, the first die, and the second die.

14. The sensor assembly of claim 13, wherein the first outer surface has a first contact and the second outer surface has a second contact, the integrated circuit is electrically connected to the first subset and the second subset through the first contact and the second contact.

15. The sensor assembly of claim 1, wherein the first subset is disposed on a side of the first diaphragm facing the first outer surface and/or the second subset is disposed on a side of the second diaphragm facing the second outer surface.

16. The sensor assembly of claim 1, wherein first die and the second die are each a silicon material.

17. The sensor assembly of claim 16, wherein the piezoresistive elements are an elemental material patterned over or embedded into the silicon material of the first die and the second die.

18. The sensor assembly of claim 1, wherein the full-bridge pressure sensor includes four piezoresistive elements, the first subset is a first half-bridge of two piezoresistive elements on the first diaphragm and the second subset is a second half-bridge of two piezoresistive elements on the second diaphragm.

19. The sensor assembly of claim 1, wherein the first subset on the first diaphragm lies in a first plane parallel to the first outer surface and the second subset on the second diaphragm lies in a second plane parallel to the second outer surface, the first plane is separated from the second plane.

20. The sensor assembly of claim 7, wherein the integrated circuit is disposed on the first die and/or the second die.
